(19) United States
(12) Patent Application Publication
(10) Pub. No.: US 2022/0186858 A1
(43) Pub. Date: Jun. 16, 2022

(54) COOLANT HOSE

(71) Applicant: CONTITECH TECHNO-CHEMIE GMBH, Karben (DE)

(72) Inventors: Alexandra Brandt, Gotha (DE); Michael Sont, Horneburg (DE)

(73) Assignee: CONTITECH TECHNO-CHEMIE GMBH, Karben (DE)

(21) Appl. No.: 17/593,045

(22) PCT Filed: Jan. 27, 2020
(86) PCT No.: PCT/EP2020/051843

§ 371 Date: Sep. 7, 2021

(30) Foreign Application Priority Data
Mar. 11, 2019 (DE) 10 2019 203 254.0

(51) Int. Cl. F16L 11/08; B32B 25/08; B32B 25/10; B32B 25/14; B32B 27/30; B32B 27/32; B32B 27/34; B32B 5/02

(52) U.S. Cl. CPC F16L 11/085; F16L 2011/047; B32B 25/10; B32B 25/14; B32B 27/306; B32B 27/32; B32B 27/34; B32B 5/026; F16L 11/082; B32B 2262/0223; B32B 2262/0269; B32B 2262/0284; B32B 2270/00; B32B 2307/546; B32B 2307/7265; B32B 2597/00; B32B 25/08

(57) ABSTRACT

The invention relates to a refrigerant hose which has at least the following layer structure:
an interior layer (A) which acts as barrier layer and which is composed of at least two plies (A1, A2), wherein at least one ply (A1) is constructed from an elastomer-modified EVOH or a polyolefin-modified EVOH or of a combination of an elastomer-modified EVOH and a polyolefin-modified EVOH, and
at least one reinforcement layer (B) and
an exterior layer (C) which is composed of at least one elastomeric material.

The invention relates to a refrigerant hose which has at least the following layer structure:
an interior layer which acts as barrier layer and which is composed of at least two plies, and
at least one reinforcement layer and
an exterior layer which is composed of at least one elastomeric material.

Refrigerant hoses which are installed in air-conditioning systems for the automobile industry generally contain fluorocarbons as refrigerant. When this type of refrigerant escapes into the atmosphere it has an adverse effect on the environment, e.g. in the form of acid rain, the greenhouse effect or degradation of the ozone layer. CO₂ is a more environmentally friendly refrigerant. However, because of its molecular size and its physical and chemical properties it subjects the air-conditioning system to more stringent requirements and demands; compliance with, or solutions for, these require novel hose systems, inter alia.

Hoses used for conventional refrigerants mostly consist of three different layers: an internal layer, a reinforcement layer and an external layer, where the external layer and the internal layer are mostly composed of an elastomeric material and the internal layer is often configured from more than one ply and additionally has an integrated ply which is made of a thermoplastic material and which significantly improves the barrier property of the hose in respect of refrigerant loss, but at the same time impairs the flexibility of the hose. The following can be used inter alia as elastomers for the internal layer and/or the external layer: EPDM, EPM, BIMS, BIIR, CIIR, IIR, CM, AEM, ACM, CR, NBR, HNBR, alone or in combination.

The reinforcement layer mostly consists of organic fiber systems, e.g. polyester yarn, polyamide yarn, rayon yarn, aramid yarn or PVOH yarn, and is generally present in braided or spiralized, i.e. wound, form. In the case of the spiralized hose, two reinforcement layers are generally used, which can be identical or different from one another. A further elastomer layer can be integrated as intermediate layer between the two wound fiber layers. In order to generate or to optimize the adhesion between the various layers, adhesion-promoter layers can also be added to the layer structure.

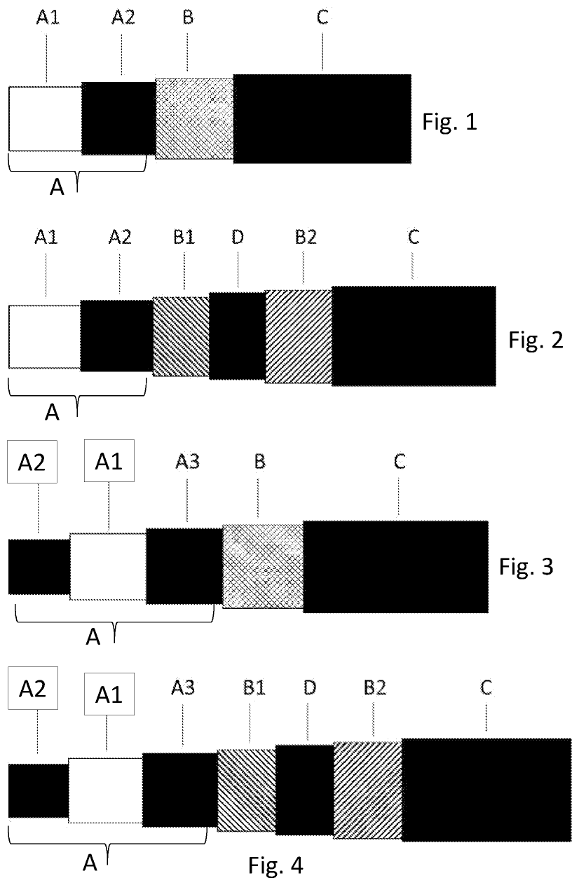

The thermoplastic ply of the internal layer can either be in the interior of the hose (veneer hose, see FIGS. 1 and 2) or be embedded as barrier ply between two further plies of the internal layer (barrier hose, see FIGS. 3 and 4). Polyamides have proven successful as material for the barrier ply. In particular, impact-modified grades of PA.6 are utilized, because they currently provide a good compromise between the flexibility and barrier function for production of air-conditioning hoses.

The hose structure described above therefore provides sufficient flexibility to the hose for installation in a confined space, while also exhibiting barrier properties that are sufficiently good to, for example, provide an adequate degree of reduction of refrigerant loss of the refrigerants R134a (1,1,1,2-tetrafluoroethane) or R1234yf (2,3,3,3-tetrafluoropropene).

As already mentioned above, the hose structure mentioned must be newly conceived for the use with CO₂ as a refrigerant, because the widely used air-conditioning hoses do not exhibit an adequate barrier function in relation to CO₂.

In order to optimize the barrier function, i.e. in order to provide further avoidance of refrigerant loss, US20040118469A1 proposes use of a ply which is based on EVOH which exhibits a significantly better barrier property in relation to PA.6.

However, that type of hose has shortcomings in terms of flexibility and exposure to dynamic mechanical loads. Cracking in the EVOH ply caused by sudden loads, or during low-temperature flexibility tests occurs relatively rapidly in the above type of hose.

It is therefore an object of the present invention to provide a refrigerant hose which firstly features a fluid-resistant internal layer with optimized barrier effect in relation to the refrigerant, in particular in relation to CO₂, and which secondly features sufficient flexibility and high resistance to dynamic mechanical loads.

This object is achieved via a refrigerant hose which has at least the following layer structure:
an interior layer which acts as barrier layer and which is composed of at least two plies, wherein at least one ply is constructed from an elastomer-modified EVOH or a polyolefin-modified EVOH or of a combination of an elastomer-modified EVOH and a polyolefin-modified EVOH, and
at least one reinforcement layer and
an exterior layer which is composed of at least one elastomeric material.

Surprisingly, it has been found that use of a specially modified EVOH provides, in comparison with unmodified EVOH, increased flexibility and, associated therewith, improved dynamic-mechanical strength.

The barrier layer in the invention is composed of at least two plies and has at least one ply which is composed of an elastomer- or polyolefin-modified EVOH or of a combination of the two. This ply forms what is known as the barrier ply of the hose. The ethylene content of the EVOH present in the barrier ply here (not including content of elastomer and, respectively, of polyolefin from the modification) is between 10 and 44%, preference being given here to a smaller content between 27 and 29%, in order to retain maximized barrier effect and also maximized melting point. The modified EVOH comprises 5 to 40% by weight of elastomer or polyolefin or a combination of the two, preference being given here to selection of 10% by weight of elastomer in order firstly to provide sufficient flexibility and, respectively, impact modification to the EVOH, while at the same time retaining maximized barrier effect of the entire material. The elastomer for the modification is preferably a nonpolar elastomer which moreover is either entirely or to some extent modified for compatibility, so that it can participate in a homogeneous composite with the EVOH. Particularly good results can be achieved with the use of a maleic anhydride-grafted elastomer. However, it is also possible to conceive of other modifications of the elastomer or polyolefin by other functional groups, as long as these can participate in bonding to the EVOH.

For a good compromise between sufficient barrier effect and stiffness of the hose, the ply thickness of the barrier ply is preferably between 0.02 and 0.3 mm.

The barrier layer, which is also termed internal layer hereinafter, also comprises at least one further second ply, alongside the barrier ply described. The following can be used as polymeric materials for this further second ply: polyamides, polyolefins, thermoplastic elastomers and other elastomers, and also combinations thereof. Among these can be, inter alia, the following materials: PP, PE, PMP, TPC, PA6, PA66, PA11, PA12, PA46, PA610, PA9T, PA6T, EPM, EPDM, BR, IIR, BIIR, CIIR, BIMS. When a polyamide is used, this is preferably impact-modified, e.g. via reactive extrusion with a maleic-anhydride-grafted polyolefin, in order to increase the flexibility of the material and to reduce cracking on exposure to mechanical load (for example in the event of a sudden load or the hose reinforcement).

The thickness of the further second ply is preferably between 0.05 and 0.5 mm, particularly preferably between 0.15 and 0.3 mm.

In a particularly preferred embodiment, the internal layer consists of the two plies mentioned, where the further second ply, which forms the innermost ply of the hose, serves as protective layer for the barrier ply and can, with suitable selection of material, also make a positive contribution to the barrier function of the barrier ply. The selection of material may necessitate modification of the material for compatibility, so that it can participate in adhesion to the barrier ply. This can by way of example likewise be realized via maleic-anhydride grafting.

In another particularly preferred embodiment, the internal layer consists of three plies, where the further second ply which forms the innermost layer of the hose serves as protective layer for the barrier ply (by analogy with the two-ply structure of the internal layer) and the additional third ply is preferably composed of at least one elastomer. The following are preferably used as elastomers: EPDM, EPM, BIMS, BIIR, CIIR, IIR, CM, AEM, ACM, CR, NBR or HNBR or a combination of these. The barrier properties of the additional third ply can be optimized via addition of phyllosilicates, graphenes or other laminar fillers with high aspect ratio. The third ply is preferably present in extruded form.

Insofar as an additional third ply is present, its thickness is preferably between 0.2 and 2 mm, particularly preferably between 0.2 and 0.5 mm.

The hose of the invention moreover comprises at least one reinforcement layer and one exterior layer, i.e. external layer.

The reinforcement layer is applied by braiding or spiralizing. Knitting is also possible for applications where pressure requirements are not stringent. The following are suitable as material for the reinforcement layer, depending on pressure requirement: preferably aramids, for example p-aramid or m-aramid, polyamides, PET or PVOH or a combination of these in the form of hybrid systems.

The exterior layer in the invention is composed of at least one elastomeric material, which can preferably be EPDM, EPM, BIMS, BIIR, CIIR, IIR, CM, AEM, ACM, CR, NBR or HNBR, or a combination thereof. The barrier properties of the exterior layer can be optimized by addition of phyllosilicates, graphenes or other laminar fillers with high aspect ratio. The exterior layer is preferably present in extruded form.

The thickness of the exterior layer is preferably between 0.2 and 2 mm, particularly preferably between 0.7 and 1.5 mm.

In a particularly preferred embodiment, the refrigerant hose also comprises at least one intermediate layer. The intermediate layer is preferably composed of at least one elastomeric material, which can advantageously be EPDM, EPM, BIMS, BIIR, CIIR, IIR, CM, AEM, ACM, CR, NBR or HNBR or a combination thereof. The barrier properties of the intermediate layer can be optimized by addition of phyllosilicates, graphenes or other laminar fillers with high aspect ratio. The intermediate layer is preferably present in extruded form.

The thickness of the intermediate layer is preferably between 0.1 and 1.5 mm, particularly preferably between 0.2 and 0.7 mm.

There is preferably sufficiently good adhesion between all of the layers, which in a preferred embodiment is provided via integration of thin adhesion-promotor layers between the plies and/or between the layers.

The individual plies and/or layers of the refrigerant hose are preferably applied in extruded form on a mandrel. The hose is then vulcanized or partially vulcanized and removed from the mandrel. The partially vulcanized hose can be used for molded hose production, and is finally vulcanized in the shaping process.

The invention will now be explained on the basis of a working example with reference to experimental results and diagrams.

### Experimental Results

Table 1 shows various physical test results on the basis of a refrigerant hose of the prior art V1 and of a refrigerant hose E1 of the invention. The test results were obtained on the basis of DIN Spec 74106. The evaluation “+” means that the test was passed; the evaluation “−” means that the test was not passed.

The hose structure here was as follows:

Further second internal ply A2: PA6 (Orgalloy LT5050, Arkema), ply thickness 0.3 mm
Barrier ply A1: elastomer-modified EVOH (Eval LA170B, Kuraray) (E1) or unmodified EVOH (Evasin 2951F, Arkema) (V1), ply thickness 0.1 mm
Additional third internal ply A3: BIIR, ply thickness 1.1 mm Reinforcement layer B: p-aramid, braided
Exterior layer C: EPM, layer thickness 0.85 to 1 mm

TABLE 1

| | | | Requirement in accordance |
|---|---|---|---|
| | V1 | E1 | with DIN Spec 74106 |
| Tensile strength | + | + | ≥2500N |
| Dimensional | + | + | Max 5% |
| stability under | | | |
| vacuum | | | |
| Sudden load test | − | + | 0 to 120° C./25 to |
| | | | 100 bar/150 000 cycles |
| Low-temperature | − | + | Artificial aging for 48 h/70° C., |
| resistance | | | storage for 24 h, −30° C. |
| Buckling resistance | + | + | ±0.6 mm |

The refrigerant hose E1 of the invention is suitable as refrigerant hose for use in the low-temperature regions of an air-conditioning system (for very short periods max. 130° C.) and CO₂ as refrigerant. It features a high level of barrier properties, resistance to fluids in the form of compressor oils, good low-temperature flexibility and good performance in relation to sudden load. The comparative hose V1 with the unmodified EVOH fails after only short exposure to sudden load and does not exhibit high low-temperature flexibility.

### DIAGRAMS

FIG. 1 shows a refrigerant hose in the form of a veneer hose of the prior art with a braided reinforcement layer B, a two-ply structure of the internal layer A, where the thermoplastic ply A1 of the internal layer A consists of polyamide and, as barrier ply, forms the innermost ply of the internal layer A, and with a further second ply A2 of the internal layer A, and with an exterior layer C.

FIG. 2 shows a refrigerant hose in the form of a veneer hose of the prior art with two spiralized reinforcement layers B1, B2, a two-ply structure of the internal layer A, where the thermoplastic ply A1 of the internal layer A consists of polyamide and, as barrier ply, forms the innermost ply of the internal layer A, and with a further second ply A2 of the internal layer A, and with an additional elastomeric intermediate layer D and an exterior layer C.

FIG. 3 shows a refrigerant hose in the form of a barrier hose of the prior art with a braided reinforcement layer B, a three-ply structure of the internal layer A, where the thermoplastic ply A1 of the internal layer made of polyamide is embedded, as barrier ply, between two further plies A2, A3 of the internal layer A, and with a further second ply A2 of the internal layer A, an additional third ply A3 of the internal layer A and an exterior layer C.

FIG. 4 shows a refrigerant hose in the form of a barrier hose of the prior art with two spiralized reinforcement layers B1, B2, a three-ply structure of the internal layer A, where the thermoplastic ply A1 of the internal layer A made of polyamide is embedded, as barrier ply, between two further plies A2, A3 of the internal layer A, and with a further second ply A2 of the internal layer A, an additional third ply A3 of the internal layer A, and with an additional elastomeric intermediate layer D, and an exterior layer C.

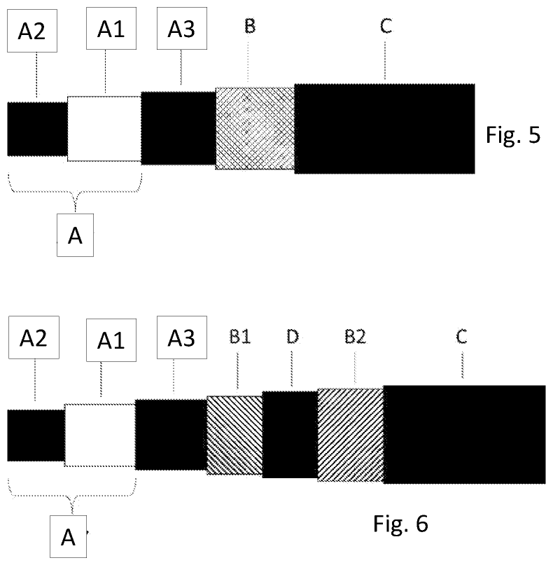

FIG. 5 shows a refrigerant hose of the invention with a braided or knitted reinforcement layer B, a three-ply structure of the internal layer A, where the barrier ply A1 of the internal layer A made of elastomer-modified EVOH or of polyolefin-modified EVOH is embedded between two further plies A2, A3 of the internal layer A, and with a further second ply A2 of the internal layer A, an additional third ply A3 of the internal layer A, and an exterior layer C. The materials of the two further plies A2, A3 of the internal layer A are different from the material of the barrier ply A1.

FIG. 6 shows a refrigerant hose of the invention with two spiralized reinforcement layers B1, B2, a three-ply structure of the internal layer A, where the barrier ply A1 of the internal layer A made of elastomer-modified EVOH or of polyolefin-modified EVOH is embedded between two further plies A2, A3 of the internal layer A, and with a further second ply A2 of the internal layer A, an additional third ply A3 of the internal layer A, an additional intermediate layer D, and an exterior layer C. The materials of the two further plies A2, A3 of the internal layer A are different from the material of the barrier ply.

### LIST OF REFERENCE SIGNS

### (Part of the Description)

A Internal layer
A1 Barrier ply of the internal layer
A2 Further second ply of the internal layer
A3 Additional third ply of the internal layer
B Single reinforcement layer
B1 First reinforcement layer
B2 Second reinforcement layer
D Elastomeric intermediate layer
C Exterior layer

1.-6. (canceled)

7. A refrigerant hose comprising:
an interior layer (A) which acts as barrier layer and which is composed of at least two plies (A1, A2), wherein at least one ply (A1) is constructed from an elastomer-modified EVOH, a polyolefin-modified EVOH, or a combination of the elastomer-modified EVOH and the polyolefin-modified EVOH;
at least one reinforcement layer (B); and,
an exterior layer (C) which is composed of at least one elastomeric material.

8. The refrigerant hose as claimed in claim 7, wherein the interior layer (A) consists of two layers (A1, A2).

9. The refrigerant hose as claimed in claim 7, wherein the interior layer (A) consists of three layers (A1, A2, A3).

10. The refrigerant hose as claimed in claim 7, wherein the ethylene content in EVOH present in the elastomer-modified EVOH and/or the polyolefin-modified EVOH is between 10 and 44 mol %.

11. The refrigerant hose as claimed in claim 7, wherein the elastomer content in the elastomer-modified EVOH comprises a compatible elastomer.

12. The refrigerant hose as claimed in claim 11, wherein the compatible elastomer is a nonpolar elastomer.

13. The refrigerant hose as claimed in claim 7, wherein the elastomer content in the elastomer-modified EVOH consists of a compatible elastomer.

14. The refrigerant hose as claimed in claim 13, wherein the compatible elastomer is a nonpolar elastomer.

15. The refrigerant hose as claimed in claim 7, wherein the at least one reinforcement layer (B) is two reinforcement layers (B1, B2).

16. The refrigerant hose as claimed in claim 15 further comprising an additional intermediate layer (D) between the two reinforcement layers (B1, B2).

17. The refrigerant hose as claimed in claim 15, wherein the two reinforcement layers (B1, B2) are spiralized reinforcement layers.

18. The refrigerant hose as claimed in claim 15, wherein the interior layer (A) consists of three layers (A1, A2, A3).

19. The refrigerant hose as claimed in claim 15, wherein the interior layer (A) consists of two layers (A1, A2).

20. The refrigerant hose as claimed in claim 7, wherein the hose consists of the interior layer (A) which consists of three layers (A1, A2, A3), the at least one reinforcement layer (B) which consists of one reinforcement layer, and the exterior layer (C).

21. The refrigerant hose as claimed in claim 7, wherein the hose consists of the interior layer (A) which consists of two layers (A1, A2), the at least one reinforcement layer (B) which consists of one reinforcement layer, and the exterior layer (C).

22. The refrigerant hose as claimed in claim 7, wherein an innermost ply (A1) of the of the at least two plies (A1, A2) comprises polyamide.

23. The refrigerant hose as claimed in claim 7, wherein the interior layer (A) consists of three plies (A1, A2, A3), and wherein embedded between an innermost ply (A2) and an outermost ply (A3) is a thermoplastic ply (A1).

24. The refrigerant hose as claimed in claim 23, wherein the thermoplastic ply (A1) comprises polyamide.

25. The refrigerant hose as claimed in claim 23, wherein the at least one reinforcement layer (B) is at least one braided reinforcement layer.

26. The refrigerant hose as claimed in claim 23, wherein the at least one reinforcement layer (B) is two spiralized reinforcement layers (B1, B2) having an additional intermediate layer disposed therebetween.
